(19) United States
(12) Patent Application Publication
(10) Pub. No.: US 2021/0179131 A1
(43) Pub. Date: Jun. 17, 2021

(54) DRIVER ASSISTANCE DEVICE, NON-TRANSITORY STORAGE MEDIUM STORING DRIVER ASSISTANCE PROGRAM, AND DRIVER ASSISTANCE SYSTEM

(71) Applicant: Toyota Jidosha Kabushiki Kaisha, Toyota-shi Aichi-ken (JP)

(72) Inventors: Atsushi Maeda, Nagoya-shi (JP); Yuma Ishihara, Nagoya-shi (JP)

(73) Assignee: Toyota Jidosha Kabushiki Kaisha, Toyota-shi Aichi-ken (JP)

(21) Appl. No.: 17/113,596

(22) Filed: Dec. 7, 2020

(30) Foreign Application Priority Data
Dec. 13, 2019 (JP) 2019-225827

(51) Int. Cl. B60W 50/14; B60W 30/18; G10L 15/22; B60W 40/09

(52) U.S. Cl. CPC B60W 50/14; B60W 30/18; G10L 15/22; B60W 2540/21; B60W 2050/143; B60W 2050/146; B60W 2420/42; B60W 40/09

(57) ABSTRACT

A driver assistance device includes a display, a speaker, a microphone, and a processor that includes hardware, and is configured to: acquire first information indicating information relating to a behavior of a driver of a vehicle from a first device that is mounted in the vehicle and is configured to perform an external communication and; display an image of inside of the vehicle that is acquired from a camera provided in the vehicle on the display and cause the speaker and the microphone to establish a condition where a dialogue with the driver in the vehicle is allowed when the first information includes an abnormal behavior of the driver.

### CROSS-REFERENCE TO RELATED APPLICATION

This application claims priority to Japanese Patent Application No. 2019-225827 filed on Dec. 13, 2019, which is incorporated herein by reference in its entirety, including the specification, drawings and abstract.

### BACKGROUND

### 1. Technical Field

The present disclosure relates to a driver assistance device, a non-transitory storage medium that stores a driver assistance program, and a driver assistance system.

### 2. Description of Related Art

Japanese Unexamined Patent Application Publication No. 2014-044691 (JP 2014-044691 A) discloses a drive recorder system that includes cameras provided inside and outside of a vehicle, and that issues an alert (warning) and records the inside of a cabin when the driver recorder system detects an abnormal behavior of a driver, such as falling asleep.

### SUMMARY

There has been a demand for a technology that further improves a driving safety of a driver.

The present disclosure provides a driver assistance device, a non-transitory storage medium that stores a driver assistance program, and a driver assistance system that can improve the driving safety.

A driver assistance device according to a first aspect of the present disclosure includes a display; a speaker; a microphone; and a processor that includes hardware, and is configured to acquire first information indicating information relating to a behavior of a driver of a vehicle from a first device that is mounted in the vehicle that is configured to perform an external communication and display an image of inside of the vehicle that is acquired from a camera provided in the vehicle on the display and cause the speaker and the microphone to establish a condition where a dialogue with the driver in the vehicle is allowed when the first information includes an abnormal behavior of the driver.

A non-transitory storage medium according to a second aspect of the present disclosure stores a driver assistance program that causes a processor including hardware to perform: acquiring first information indicating information relating to a behavior of a driver from a first device that is mounted in a vehicle that is configured to perform external communication; and displaying an image of inside of the vehicle that is acquired from a camera provided in the vehicle on a display provided on a driver assistance device and causing a speaker and a microphone that are provided for the driver assistance device to establish a condition where a dialogue with the driver in the vehicle is allowed when the first information includes an abnormal behavior of the driver.

A driver assistance system according to a third aspect of the present disclosure includes: a first device including a first processor that includes hardware, a first device being mounted in a vehicle that is configured to perform external communication and is configured to transmit first information indicating information relating to a behavior of a driver; and a server including a display, a speaker, a microphone, and a second processor that has hardware and is configured to: acquire the first information from the first device; and display an image of inside of the vehicle that is acquired from a camera provided in the vehicle and cause the speaker and the microphone to establish a condition where a dialogue with the driver in the vehicle is allowed when the first information includes an abnormal behavior of the driver.

According to the present disclosure, when the abnormal behavior of the driver occurs, an operator, for example, can instruct the driver to drive the vehicle properly while checking a condition in the vehicle in real time as the driver assistance system distributes the image of the inside of the vehicle and allows the operator to have a dialogue with the driver. Accordingly, the driving safety can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically showing a configuration of a driver assistance system including the driver assistance device according to a first embodiment;

FIG. 2 is a diagram showing an example of a display screen that is displayed on a display unit by a display control unit of the driver assistance device according to the first embodiment;

FIG. 3 is a flowchart showing a processing procedure of a driver assistance method that is performed by the driver assistance system according to the first embodiment; and

FIG. 4 is a block diagram schematically showing a configuration of a driver assistance system including a driver assistance device according to a second embodiment.

### DETAILED DESCRIPTION OF EMBODIMENTS

### First Embodiment

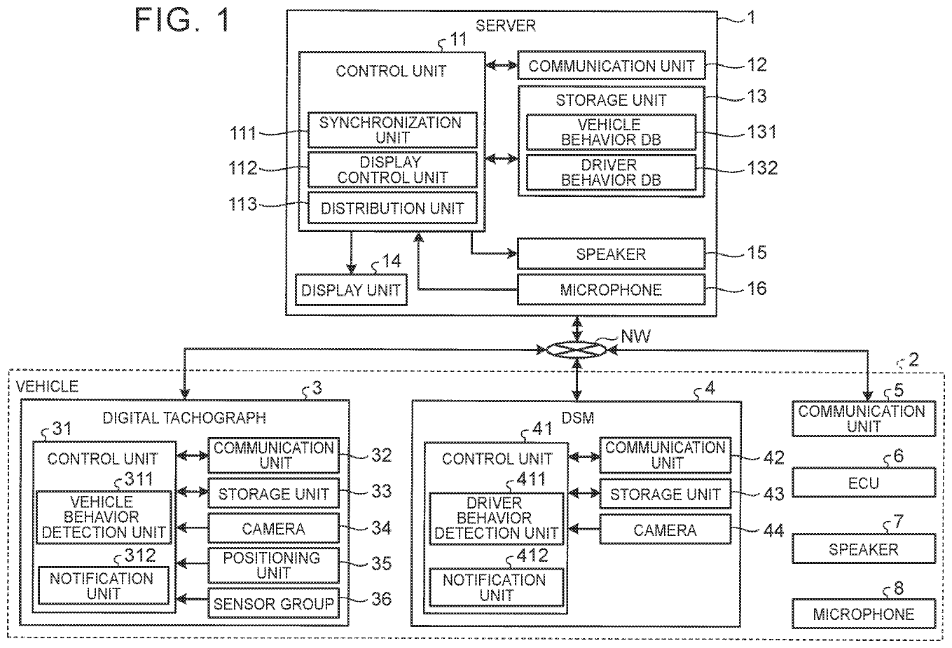

A driver assistance device, a driver assistance program, and a driver assistance system according to a first embodiment of the present disclosure will be described with reference to FIGS. 1 to 3. Note that, constituent elements of embodiments below include elements that can be replaced and easily achieved by those who skilled in the art and elements that are substantially identical.

### Driver Assistance System

The driver assistance system including the driver assistance device according to the first embodiment will be described with reference to FIG. 1. The driver assistance system provides a driver assistance based on information relating to behaviors of a driver that is received (acquired) from an on-board device. As shown in FIG. 1, the driver assistance system includes a server 1, a digital tachograph 3, and a driver status monitor (hereinafter referred to as “DSM”) 4. Specifically, the driver assistance device according to the first embodiment is realized by the server 1.

The digital tachograph 3 and the DSM 4 are mounted in a vehicle 2 as on-board devices. The vehicle 2 is a moving body that is communicable with the outside, and is, for example, an autonomous vehicle that is capable of autonomous driving. The vehicle 2 includes a communication unit 5, an electronic control unit (ECU) 6, a speaker 7, and a microphone 8, in addition to the digital tachograph 3 and the DSM 4. Although only one unit of the vehicle 2 is shown in FIG. 1, a plurality of the vehicles 2 may be provided.

The server 1, the digital tachograph 3, the DSM 4, and the communication unit 5 of the vehicle 2 are configured to be communicable with each other via a network NW. The network NW is configured of the Internet network and a mobile phone network, for example.

### Server

The server 1 acquires data (e.g. vehicle behavior information (second information)) output from the digital tachograph (second device) 3 and data (e.g. driver behavior information (first information)) output from the DSM (first device) 4 via the network NW, accumulates the output data above in a synchronously reproducible state, and reproduces the data in synchronization with each other. The server 1 includes a control unit 11, a communication unit 12, a storage unit 13, a display unit (display) 14, a speaker 15, and a microphone 16.

Specifically, the control unit 11 includes a processor having a central processing unit (CPU), a digital signal processor (DSP), and a field-programmable gate array (FPGA), etc., and a memory (main storage unit) having a random access memory (RAM) and a read-only memory (ROM), etc.

The control unit 11 realizes a function that matches a predetermined purpose by loading a program stored in the storage unit 13 to a workspace of the main storage unit, executing the program, and controlling each constituent unit through execution of the program. The control unit 11 functions as a synchronization unit 111, a display control unit 112, and a distribution unit 113 through execution of the program.

The synchronization unit 111 accumulates the vehicle behavior information and the driver behavior information received via the network NW in the storage unit 13 in a synchronously reproducible manner. After receiving the vehicle behavior information from the digital tachograph 3 and the driver behavior information from the DSM 4, the synchronization unit 111 synchronizes the vehicle behavior information with the driver behavior information in terms of time based on time information included in the vehicle behavior information and the driver behavior information and accumulates the synchronized information in the storage unit 13.

Here, the vehicle behavior information is information that relates to behaviors of the vehicle 2 and is generated by the digital tachograph 3. The vehicle behavior information includes sensor values such as a vehicle speed, an angular velocity, an inter-vehicle distance with surrounding vehicles, and gravitational acceleration (G) values (front-rear G, right-left G, and vertical G) that are detected by a sensor group 36, a vehicle position (coordinate) detected by a positioning unit 35, information relating to whether an abnormal behavior of the vehicle 2 occurs, and the time information. Examples of the abnormal behavior of the vehicle 2 include rapid acceleration, steep turn, rapid approach to the surrounding vehicle, or crossing over a lane marking line by the vehicle 2. The digital tachograph 3 outputs an image that is captured by cameras 34 and the vehicle behavior information above to the synchronization unit 111 of the server 1.

The driver behavior information is information that relates to behaviors of the driver of the vehicle 2 and is generated by the DSM 4. The driver behavior information includes information on whether there is an abnormal behavior of the driver, such as looking away by the driver (the driver looks aside), closure of the driver's eyes (falling asleep), swinging of the driver's head, and disturbance in a driving posture of the driver, occurs. The DSM 4 outputs an image captured by a camera 44 and the driver behavior information above to the synchronization unit 111 of the server 1.

A transport vehicle and a route bus that travel along a determined route at a determined time, for example, are assumed as the vehicle 2 that is operated with the driver assistance system according to the first embodiment. That is, a professional driver who specializes in driving is assumed as the driver of the vehicle 2. Therefore, it can be said that the vehicle behavior information and the driver behavior information are information that is received from the vehicle 2 that repeatedly travels along the same route at the same time (in the same time of day).

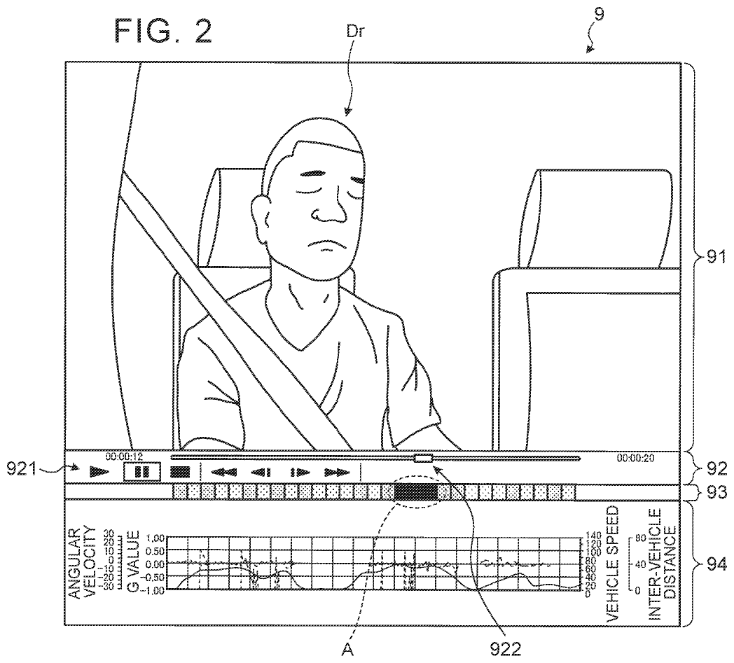

The display control unit 112 synchronizes the vehicle behavior information with the driver behavior information and causes the display unit 14 to display the synchronized information. FIG. 2 shows an example of a display screen 9 that the display control unit 112 causes the display unit 14 to display. The display screen 9 is configured to include, for example, an image display region 91 that displays the image captured by the camera 34 that captures images of the driver in the vehicle 2 (hereinafter referred to as an “in-vehicle image”) among the cameras 34 provided for the digital tachograph 3, an operation region 92 in which an operation to reproduce the in-vehicle image is possible, a driver behavior information display region 93 that displays the driver behavior information, and a vehicle behavior information display region 94 that displays the vehicle behavior information. The image display region 91 in FIG. 2 displays the in-vehicle image. However, the image display region 91 may display an image captured by the camera 34 that captures images outside the vehicle 2 (hereinafter referred to as “external image”) among the cameras 34 provided for the digital tachograph 3. Further, the display control unit 112 may display a switching button, etc., in the image display region 91 to switch between the in-vehicle image and the external image.

The display control unit 112 displays, for example, the in-vehicle image of a driver Dr seated on a driver's seat in the image display region 91. The display control unit 112 displays an operation button group 921 including, for example, a play button, a pause button, a stop button, a rewind button, and a fast forward button for the in-vehicle images, and a seek bar 922 in the operation region 92. The operation button group 921 and the seek bar 922 are operable by a pointing device such as a mouse. A movable direction of the seek bar 922 (a right-left direction in FIG. 2) is consistent with a time axis direction. Therefore, the in-vehicle image corresponding to a certain time point can be displayed in the image display region 91 by moving the seek bar 922 to the right and to the left.

When the display control unit 112 synchronizes the vehicle behavior information with the driver behavior information and displays the synchronized information on the display unit 14, the display control unit 112 applies different colors to types of abnormal behaviors (e.g. looking away by the driver, closure of the driver's eyes, swinging of the driver's head, and disturbance in the driving posture of the driver) and displays a section in which an abnormal behavior of the driver occurs in accordance with the color applied to the abnormal behavior. As shown in FIG. 2, for example, the display control unit 112 displays regions that are partitioned by a predetermined time in a grid pattern side by side in a time axis direction in the driver behavior information display region 93, and the grids are displayed with different colors in accordance with the types of abnormal behaviors. For example, the color in the grid in a portion A in FIG. 2 indicates that the driver closes his or her eyes. As described above, the sections in which the abnormal behaviors of the driver occur are displayed in different colors in accordance with the type of abnormal behaviors. This makes it possible to understand the abnormal behaviors of the driver at a glance.

As shown in FIG. 2, for example, the display control unit 112 displays a graph indicating the information on, for example, the vehicle speed, the angular velocity, the inter-vehicle distance with the surrounding vehicle, and the G values in the vehicle behavior information display region 94. Further, the display control unit 112 may display, for example, coordinates of the vehicle position on a map, or display the sections in which the abnormal behaviors of the vehicle 2 occur using different colors in accordance with the types of abnormal behaviors (e.g. rapid acceleration, steep turn, rapid approach to the surrounding vehicle, or crossing over the lane marking line by the vehicle 2), in addition to the graph shown in FIG. 2. As described above, displaying the behavior of the vehicle 2 in a graph or displaying the sections in which the abnormal behaviors of the vehicle 2 occur using different colors makes it possible to understand the abnormal behaviors of the vehicle 2 at a glance.

When the display control unit 112 synchronizes the vehicle behavior information with the driver behavior information and displays the synchronized information on the display unit 14, the display control unit 112 may display only the section in which the abnormal behavior of the driver included in the driver behavior information continues. That is, as shown in a portion A in FIG. 2, the display control unit 112 may extract the information and the image of a portion in which the same abnormal behavior of the driver (e.g. closure of the eyes) continues and displays the extracted information and image on the display unit 14. With this configuration, a user that administrates the server 1 (hereinafter referred to as an “operator”) can preferentially check only the portion in which the abnormal behavior of the driver is highly likely to occur.

Moreover, when the display control unit 112 synchronizes the vehicle behavior information with the driver behavior information and displays the synchronized information on the display unit 14, the display control unit 112 may extract only the information and image of the portion in which the abnormal behavior of the vehicle 2 continues included in the vehicle behavior information and display the extracted information and image on the display unit 14. Consequently, the operator can preferentially check only the portion in which the abnormal behavior of the vehicle 2 is highly likely to occur.

When the driver behavior information includes the abnormal behavior of the driver, that is, when the distribution unit 113 receives information indicating that “the abnormal behavior of the driver occurs” from the DSM 4, the distribution unit 113 displays the image received from the camera 34 of the digital tachograph 3 on the display unit 14. Consequently, the image received from the camera 34 of the digital tachograph 3 is distributed to the operator via the display unit 14. At the same time, the distribution unit 113 activates the speaker 15 and the microphone 16 to establish a condition where the driver in the vehicle can have a dialogue with the operator. With this configuration, when the abnormal behavior of the driver occurs, the operator can instruct the driver to drive the vehicle 2 properly while checking a condition in the vehicle 2 in real time.

The distribution unit 113 may distribute the in-vehicle image in advance of occurrence of the abnormal behavior of the driver. That is, even in the case where the driver behavior information received from the DSM 4 does not include the information indicating that “the abnormal behavior of the driver occurs”, the distribution unit 113 displays the image received from the camera 34 of the digital tachograph 3 on the display unit 14 when the distribution unit 113 determines that the drive behavior information includes a sign of occurrence of the abnormal behavior of the driver in accordance with predetermined determination criteria. Consequently, the image received from the camera 34 of the digital tachograph 3 is distributed to the operator via the display unit 14. At the same time, the distribution unit 113 activates the speaker 15 and the microphone 16 to establish a condition where the driver in the vehicle can communicate with the operator. With this configuration, only in the case where the abnormal behavior of the driver is highly likely to occur, the operator can instruct the driver to drive the vehicle 2 properly while checking the condition in the vehicle 2 in real time.

The determination criteria for a sign of occurrence of the abnormal behavior of the driver may be set in terms of a rate of change in an angle of the driver's face, a rate of change in the degree of opening of the eyes, and a rate of change in positions of the driver's head and body that are analyzed based on the image, for example.

The communication unit 12 is configured to include, for example, a local area network (LAN) interface board and a wireless communication circuit for performing wireless communication. The communication unit 12 is connected to the network NW such as the Internet that is a public communication network. The communication unit 12 is connected to the network NW to communicate with the digital tachograph 3, the DSM 4, and the communication unit 5 of the vehicle 2.

The storage unit 13 is configured to include a recording media such as an erasable programmable ROM (EPROM), a hard disk drive (HDD), and a removable media. Examples of the removable media includes a universal serial bus (USB) memory and disc recording medium such as a compact disc (CD), a digital versatile disc (DVD), and a Blu-ray (registered trademark) disc (BD). The storage unit 13 can store an operating system (OS), various programs, various tables, and various types of databases (DB), etc.

The storage unit 13 includes a vehicle behavior DB 131 and a driver behavior DB 132. The databases above are constructed in such a manner that a program of a database management system (DBMS) that is performed by the control unit 11 controls data to be stored in the storage unit 13.

The vehicle behavior DB 131 is configured to include a relational database in which the vehicle behavior information received from the digital tachograph 3 is stored in a searchable manner, for example. Further, the driver behavior DB 132 is configured to include a relational database in which the driver behavior information received from the DSM 4 is stored in a searchable manner, for example.

The display unit 14 is configured to include a liquid crystal display (LCD) or an organic electroluminescence display (OLED), etc. The display unit 14 displays the vehicle behavior information and the driver behavior information in synchronization with each other based on the control executed by the display control unit 112. The display unit 14 is also capable of displaying the vehicle behavior information and the driver behavior information in synchronization with each other in real time based on the control executed by the display control unit 112, or is capable of displaying the vehicle behavior information and the driver behavior information that are stored in the storage unit 13 at different timings while synchronizing the vehicle behavior information with the driver behavior information at a later timing.

The speaker 15 is an output unit that outputs voice information to the operator that administrates the server 1. The speaker 15 is used when the operator has a dialogue with the driver of the vehicle 2 via the network NW, for example. In addition, the speaker 15 may be used for the purpose of notifying the operator of an alert when the abnormal behavior of the vehicle 2 or of the driver occurs.

The microphone 16 is an input unit that receives a voice input from the operator. The microphone 16 is used when the operator has a dialogue with the driver of the vehicle 2 via the network NW, for example.

The digital tachograph (vehicle information acquisition unit) 3 includes a control unit 31, a communication unit 32, a storage unit 33, the cameras 34, a positioning unit 35, and the sensor group 36. The control unit 31, the communication unit 32, and the storage unit 33 are physically the same as the control unit 11, the communication unit 12, and the storage unit 13. The control unit 31 functions as a vehicle behavior detection unit 311 and a notification unit 312 through execution of a program stored in the storage unit 33.

The vehicle behavior detection unit 311 detects whether the behavior of the vehicle 2 (e.g. the vehicle speed, the angular velocity, the inter-vehicle distance with the surrounding vehicle, the G value, and the vehicle position) and whether the abnormal behavior of the vehicle 2 (e.g. rapid acceleration, steep turn, rapid approach to the surrounding vehicle, or crossing over the lane marking line by the vehicle 2) occurs based on the sensor data input from the sensor group 36.

The vehicle behavior detection unit 311 sets a threshold (second determination criteria) in terms of the vehicle speed, the angular velocity, the inter-vehicle distance with the surrounding vehicle, the G value, and a distance to the lane marking line, for example. The vehicle behavior detection unit 311 determines that the abnormal behavior of the vehicle 2 occurs when the sensor data input from the sensor group 36 exceeds the threshold or based on a time elapsed after the threshold is exceeded.

The notification unit 312 notifies the driver of the alert via the speaker 7 mounted in the vehicle 2 when the vehicle behavior detection unit 311 detects the abnormal behavior of the vehicle 2. Note that the notification unit 312 may output a voice prompting correction of the abnormal behavior (e.g. voice indicating that “the vehicle crosses over the lane marking line” when the vehicle crosses over the lane marking line) instead of the alert. Moreover, the digital tachograph 3 itself may include a speaker, and an alert or a voice may be output from the speaker.

The cameras 34 each are, for example, a camera having a built-in imaging element, such as a charge coupled device (CCD) or a CMOS image sensor (CIS). The cameras 34 are disposed inside and outside the vehicle, and are each disposed at a position at which an image forward of the vehicle 2 can be captured, a position at which an image rearward of the vehicle 2 can be captured, and a position at which an image of the driver in the vehicle 2 can be captured, for example. The cameras 34 output the captured image data to the vehicle behavior detection unit 311.

The positioning unit 35 receives radio waves from a global positioning system (GPS) satellite and detects the vehicle position. A method of detecting the vehicle position is not limited to the method using the GPS satellite, and may be a method of combining light detection and ranging or laser imaging detection and ranging (LiDAR) and a three-dimensional digital map, etc.

The sensor group 36 is configured to include a vehicle speed sensor, an engine speed sensor, a G sensor, and a gyro sensor, etc. The sensor group 36 outputs the detected sensor data to the control unit 31.

The DSM (driver information acquisition unit, the first device) 4 includes a control unit 41, a communication unit 42, a storage unit 43, and the camera 44. The control unit 41, the communication unit 42, and the storage unit 43 are physically the same as the control unit 11, the communication unit 12, and the storage unit 13. The control unit 41 functions as a driver behavior detection unit 411 and a notification unit 412 through execution of a program stored in the storage unit 43.

The driver behavior detection unit 411 detects the abnormal behavior of the driver by analyzing the images captured by the camera 44. The driver behavior detection unit 411 may use a machine learning technique such as deep learning when the driver behavior detection unit 411 detects the abnormal behavior of the driver.

The driver behavior detection unit 411 sets a threshold (first determination criteria) in advance in terms of the angle of the driver's face, the degree of opening of the driver's eyes, and the positions of the driver's head and body, etc., that are analyzed based on the images, for example. The driver behavior detection unit 411 determines that the abnormal behavior of the driver occurs when the result of image analysis exceeds the threshold or based on a time elapsed after the threshold is exceeded.

The notification unit 412 notifies the driver of the alert via the speaker 7 mounted in the vehicle 2 when the driver behavior detection unit 411 detects the abnormal behavior of the driver. Note that the notification unit 412 may output a voice prompting correction of the abnormal behavior (e.g. voice indicating that “pay attention to the forward” when the driver looks aside) instead of the alert. Moreover, the DSM 4 itself may include a speaker, and an alert or a voice may be output from the speaker.

The camera 44 is, for example, an infrared camera, and is disposed at a position at which an image of the driver in the vehicle 2 can be captured. The camera 44 outputs the captured image data to the vehicle behavior detection unit 311.

The communication unit 5 is configured to include a data communication module (DCM), for example, and communicates with the server 1 by a wireless communication via the network NW. The ECU 6 executes a centralized control on operations of the constituent elements mounted in the vehicle 2. The speaker 7 and the microphone 8 are provided in the vehicle 2 and are physically the same as the speaker 15 and the microphone 16. The speaker 7 and the microphone 8 may be provided in each of the digital tachograph 3 and the DSM 4.

### Driver Assistance Method

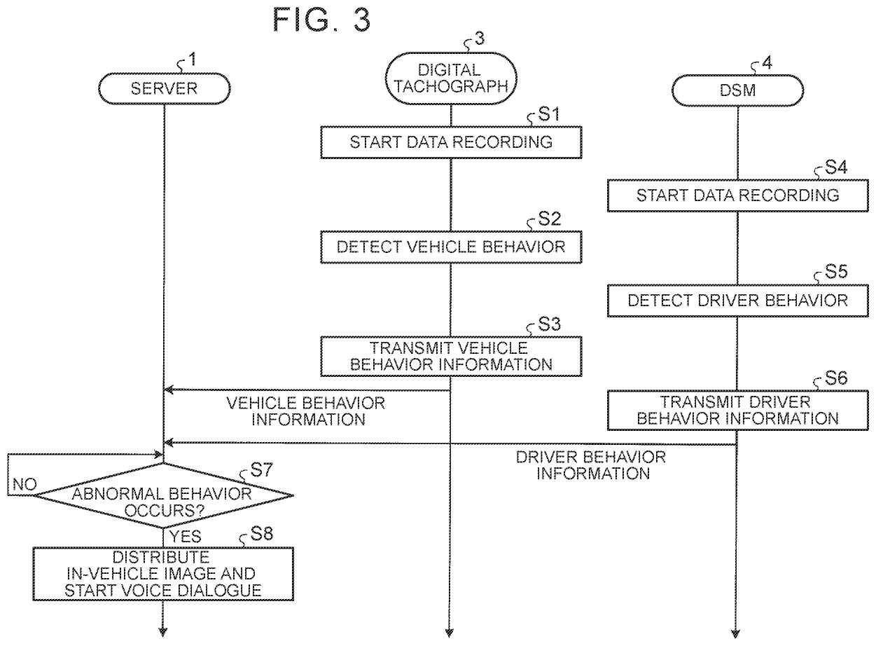

The driver assistance method that is performed by the driver assistance system according to the first embodiment will be described with reference to FIG. 3. A processing flow to be described below starts at a timing when an ignition switch of the vehicle 2 is switched from an off state to an on state, and the routine proceeds to step S1. Further, the processing (steps S1 to S3) by the digital tachograph 3 and the processing (steps S4 to S6) by the DSM 4 may be performed at different timings as shown in FIG. 3, or may be performed at the same timing.

First, the control unit 31 of the digital tachograph 3 starts data recording of the vehicle behavior information (step S1). The vehicle behavior detection unit 311 then detects the behavior of the vehicle 2 based on the sensor data input from the sensor group 36 (step S2). The vehicle behavior detection unit 311 then transmits the vehicle behavior information and the image captured by the cameras 34 to the server 1 (Step S3).

Subsequently, the control unit 41 of the DSM 4 starts data recording of the driver behavior information (step S4). The driver behavior detection unit 411 then detects the behavior of the driver based on the image input from the camera 44 (step S5). The driver behavior detection unit 411 then transmits the driver behavior information and the video (image) captured by the camera 44 to the server 1 (Step S6). After the processing in steps S5 and S6, the synchronization unit 111 of the server 1 accumulates the vehicle behavior information received from the digital tachograph 3 and the driver behavior information received from the DSM 4 in the storage unit 13 in a synchronously reproducible manner.

Subsequently, the distribution unit 113 of the server 1 determines whether the abnormal behavior of the driver occurs, that is, whether the distribution unit 113 receives the information indicating that “the abnormal behavior of the driver occurs” from the DSM 4 (step S7). When the distribution unit 113 determines that the abnormal behavior of the driver occurs (Yes in step S7), the distribution unit 113 distributes the images captured by the cameras 34 of the digital tachograph 3 to the operator via the display unit 14, activates the speaker 15 and the microphone 16 so as to make the driver in the vehicle and the operator communicable with each other, and causes the operator to start a voice dialogue (step S8).

On the other hand, when the distribution unit 113 determines that the abnormal behavior of the driver does not occur (No in step S7), the distribution unit 113 returns the routine to step S7. With the flow above, the processing of the driver assistance method ends.

As described above, with the driver assistance device, the driver assistance program, and the driver assistance system according to the first embodiment, the in-vehicle image is distributed to the operator and the operator is made possible to have a dialogue with the driver when the abnormal behavior of the driver occurs. Therefore, the operator can instruct the driver to drive the vehicle properly while the operator checking the condition in the vehicle in real time, for example. Accordingly, the driving safety can be improved.

### Second Embodiment

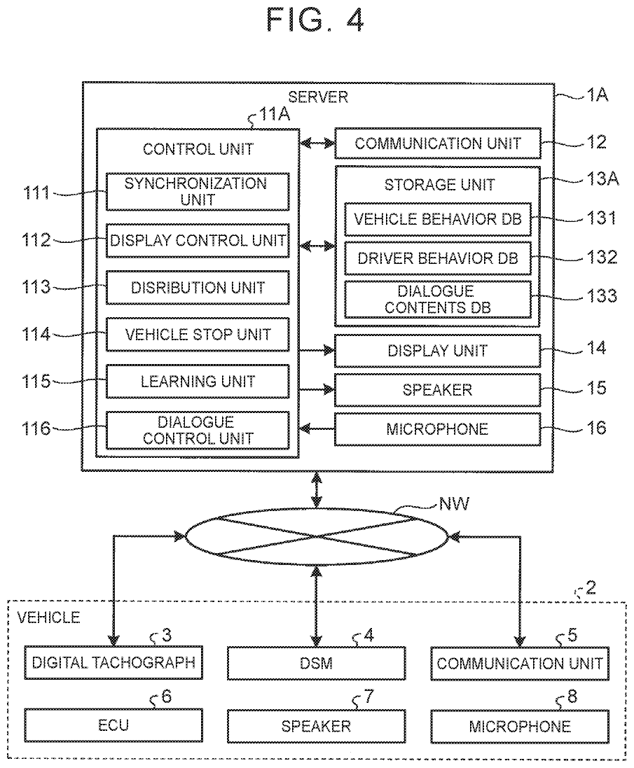

A driver assistance device, a driver assistance program, and a driver assistance system according to a second embodiment of the present disclosure will be described with reference to FIG. 4.

### Driver Assistance System

The driver assistance system according the second embodiment has the configuration similar to the driver assistance system according to the first embodiment except that the driver assistance system includes a server 1A in place of the server 1. Therefore, only the configuration of the server 1A will be described below.

### Server

The server 1A includes a control unit 11A, the communication unit 12, a storage unit 13A, the display unit 14, the speaker 15, and the microphone 16. The control unit 11A is physically the same as the control unit 11. The control unit 11A functions as the synchronization unit 111, the display control unit 112, and the distribution unit 113, a vehicle stop unit 114, a learning unit 115, and a dialogue control unit 116 through execution of the program stored in the storage unit 13A.

When the driver behavior information received from the DSM 4 includes the abnormal behavior of the driver, the vehicle stop unit 114 according to the second embodiment transmits a traveling stop signal to stop traveling of the vehicle 2 to the vehicle 2 via the network NW. The ECU 6 (refer to FIG. 1) of the vehicle 2 that receives the traveling stop signal stops the engine. Thus, a possibility of occurrence of an accident etc. can be reduced.

Further, when the driver behavior information received from the DSM 4 includes the abnormal behavior of the driver, the vehicle stop unit 114 may notify the driver of the alert using the speaker 7 of the vehicle 2 (refer to FIG. 1) via the network NW. In this case, when the vehicle stop unit 114 notifies the driver of the alert the predetermined number of times, that is, the vehicle stop unit 114 determines that the abnormal behavior of the driver repeatedly occurs, the vehicle stop unit 114 transmits the traveling stop signal to stop traveling of the vehicle 2 to the vehicle 2 via the network NW. The ECU 6 of the vehicle 2 that receives the traveling stop signal stops the engine. With this configuration, only in the case where the abnormal behavior of the driver is highly likely to occur, the vehicle 2 can be remotely stopped.

The learning unit 115 according to the second embodiment performs machine learning of a relationship between the presence of the abnormal behavior of the driver that is determined by the driver behavior detection unit 411 of the DSM 4 and the presence of actual abnormal behavior so as to generate a learning model. The learning unit 115 then determines whether the abnormal behavior of the driver occurs using the learning model generated as above instead of the determination by the driver behavior detection unit 411. With this configuration, a detection accuracy of the abnormal behavior can be improved with a use of the learning model in which the relationship between the presence of the abnormal behavior of the driver that is determined and the presence of the actual abnormal behavior is learned.

When the driver behavior information received from the DSM 4 includes the abnormal behavior of the driver, the dialogue control unit 116 according to the second embodiment analyzes the voice of the driver and has a dialogue with the driver based on predetermined dialogue contents, that is, the dialogue contents that are prestored in a dialogue contents DB 133 of the storage unit 13A. Accordingly, even when the operator is absent, a voice agent can issue an appropriate driving instruction to the driver.

As described above, the driver assistance device, the driver assistance program, and the driver assistance system according to the second embodiment can improve the detection accuracy of the abnormal behaviors of the vehicle 2 and of the driver.

Further effects and modified examples can be easily derived by those skilled in the art. Therefore, the broader aspects of the disclosure are not limited to the specific details and representative embodiments represented and described above. Accordingly, various modifications may be made without departing from the spirit and the scope of the general inventive concept as defined by the appended claims and their equivalents.

For example, in the first and second embodiments, the synchronization timing of the vehicle behavior information and the driver behavior information is not specifically limited. In the first and second embodiments, the vehicle behavior information received from the digital tachograph 3 is synchronized with the driver behavior information received from the DSM 4 in terms of time, and the synchronized information is accumulated in the storage units 13, 13A. However, the vehicle behavior information and the driver behavior information may be accumulated in the storage units 13, 13A in a state where the vehicle behavior information is not synchronized with the driver behavior information in terms of time, and may be synchronized at the time of reproduction. In this case, after the display control unit 112 reads the vehicle behavior information and the driver behavior information from the storage units 13, 13A, the display control unit 112 synchronizes the vehicle behavior information with the driver behavior information in terms of time based on the time information included in the vehicle behavior information and the driver behavior information, and displays the synchronized information on the display unit 14.

What is claimed is:

1. A driver assistance device, comprising:
a display;
a speaker;
a microphone; and
a processor that includes hardware, and is configured to
acquire first information indicating information relating to a behavior of a driver of a vehicle from a first device that is mounted in the vehicle that is configured to perform an external communication and
display an image of inside of the vehicle that is acquired from a camera provided in the vehicle on the display and cause the speaker and the microphone to establish a condition where a dialogue with the driver in the vehicle is allowed when the first information includes an abnormal behavior of the driver.

2. The driver assistance device according to claim 1, wherein the processor is configured to display the image of the inside of the vehicle that is acquired from the camera provided in the vehicle on the display and cause the speaker and the microphone to establish the condition where the dialogue with the driver in the vehicle is allowed when the processor determines that the first information includes a sign of occurrence of the abnormal behavior of the driver based on predetermined determination criteria.

3. The driver assistance device according to claim 1, wherein the processor is configured to transmit a traveling stop signal to stop traveling of the vehicle to the vehicle when the first information includes the abnormal behavior of the driver.

4. The driver assistance device according to claim 1, wherein the processor is configured to
notify the driver of an alert using an on-board speaker mounted in the vehicle when the first information includes the abnormal behavior of the driver and
transmit a traveling stop signal to stop traveling of the vehicle to the vehicle when the processor notifies the driver of the alert a predetermined number of times.

5. The driver assistance device according to claim 1, wherein the processor is configured to
generate a learning model by performing machine learning of a relationship between a presence of the abnormal behavior of the driver that is determined by the first device and a presence of an actual abnormal behavior, and
determine whether the abnormal behavior of the driver occurs using the learning model in place of a determination performed by the first device.

6. The driver assistance device according to claim 1, wherein the processor is configured to, when the first information includes the abnormal behavior of the driver,
analyze a voice of the driver and
have a dialogue with the driver based on predetermined dialogue contents.

7. The driver assistance device according to claim 1, wherein
the first device is a driver status monitor that includes the camera provided in the vehicle, and
the abnormal behavior of the driver includes at least one of looking away by the driver, closure of eyes of the driver, swinging of a head of the driver, and disturbance in a driving posture of the driver.

8. A non-transitory storage medium storing a driver assistance program that causes a processor including hardware to perform:
acquiring first information indicating information relating to a behavior of a driver from a first device that is mounted in a vehicle that is configured to perform external communication; and
displaying an image of inside of the vehicle that is acquired from a camera provided in the vehicle on a display provided on a driver assistance device and causing a speaker and a microphone that are provided for the driver assistance device to establish a condition where a dialogue with the driver in the vehicle is allowed when the first information includes an abnormal behavior of the driver.

9. The non-transitory storage medium according to claim 8, wherein the driver assistance program that causes the processor to perform, when the first information is determined to include a sign of occurrence of the abnormal behavior of the driver:
displaying the image of the inside of the vehicle that is acquired from the camera provided in the vehicle on the display; and
causing the speaker and the microphone to establish the condition where the dialogue with the driver in the vehicle is allowed.

10. The non-transitory storage medium according to claim 8, wherein the driver assistance program that causes the processor to perform transmitting a traveling stop signal to stop traveling of the vehicle to the vehicle when the first information includes the abnormal behavior of the driver.

11. The non-transitory storage medium according to claim 8, wherein the driver assistance program that causes the processor to perform:
notifying the driver of an alert using an on-board speaker mounted in the vehicle when the first information includes the abnormal behavior of the driver; and
transmitting a traveling stop signal to stop traveling of the vehicle to the vehicle when the processor notifies the driver of the alert a predetermined number of times.

12. The non-transitory storage medium according to claim 8, wherein the driver assistance program that causes the processor to perform:
generating a learning model by performing machine learning of a relationship between a presence of the abnormal behavior of the driver that is determined by the first device and a presence of an actual abnormal behavior; and
determining whether the abnormal behavior of the driver occurs using the learning model in place of a determination performed by the first device.

13. The non-transitory storage medium according to claim 8, wherein the driver assistance program that causes the processor to perform, when the first information includes the abnormal behavior of the driver,
analyzing a voice of the driver and
having a dialogue with the driver based on predetermined dialogue contents.

14. The non-transitory storage medium according to claim 8, wherein
the first device is a driver status monitor that includes the camera provided in the vehicle, and
the abnormal behavior of the driver includes at least one of looking away by the driver, closure of eyes of the driver, swinging of a head of the driver, and disturbance in a driving posture of the driver.

15. A driver assistance system comprising:
a first device including a first processor that includes hardware, the first device being mounted in a vehicle that is configured to perform external communication and is configured to transmit first information indicating information relating to a behavior of a driver; and
a server including a display, a speaker, a microphone, and a second processor that has hardware and is configured to:
acquire the first information from the first device; and
display an image of inside of the vehicle that is acquired from a camera provided in the vehicle and cause the speaker and the microphone to establish a condition where a dialogue with the driver in the vehicle is allowed when the first information includes an abnormal behavior of the driver.

16. The driver assistance system according to claim 15, wherein the second processor is configured to, when the second processor determines that the first information includes a sign of occurrence of the abnormal behavior of the driver based on predetermined determination criteria,
display the image of the inside of the vehicle that is acquired from the camera provided in the vehicle on the display and
cause the speaker and the microphone to establish the condition where the dialogue with the driver in the vehicle is allowed.

17. The driver assistance system according to claim 15, wherein the second processor is configured to transmit a traveling stop signal to stop traveling of the vehicle to the vehicle when the first information includes the abnormal behavior of the driver.

18. The driver assistance system according to claim 15, wherein the second processor is configured to
notify the driver of an alert using an on-board speaker mounted in the vehicle when the first information includes the abnormal behavior of the driver and
transmit a traveling stop signal to stop traveling of the vehicle to the vehicle when the second processor notifies the driver of the alert a predetermined number of times.

19. The driver assistance system according to claim 15, wherein the second processor is configured to
generate a learning model by performing machine learning of a relationship between a presence of the abnormal behavior of the driver that is determined by the first device and a presence of an actual abnormal behavior and
determine whether the abnormal behavior of the driver occurs using the learning model in place of a determination performed by the first device.

20. The driver assistance system according to claim 15, wherein the second processor is configured to
analyze a voice of the driver and
have a dialogue with the driver based on predetermined dialogue contents when the first information includes the abnormal behavior of the driver.
